(19) United States
(12) Patent Application Publication
(10) Pub. No.: US 2008/0227017 A1
(43) Pub. Date: Sep. 18, 2008

(54) NON-SPHERICAL RESIN PARTICLE AND PRODUCTION METHOD THEREOF

(75) Inventors: Mitsutoshi NAKAMURA, Tokyo (JP); Tatsuya NAGASE, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/019,840

(22) Filed: Jan. 25, 2008

(30) Foreign Application Priority Data
Mar. 16, 2007 (JP) 2007068450

(51) Int. Cl. G03G 9/087

(52) U.S. Cl. 430/110.3; 430/137.14

(57) ABSTRACT

A non-spherical resin particle giving a projection image viewing from at least one direction of approximately regular hexagonal shape in which each of the sides is convex to out side, wherein the particle satisfy the following formula when circumference length and the major diameter of the projection image of the non-spherical particle are each a and b, respectively,

(3/π)≦{a/(b×π)}≦C.995,

and the method for producing such the particle is characterized in that the method includes a step for forming the particle having the specific approximate hexagonal outline in a projection image viewing at least one direction by removing a swelling liquid from a swollen particle which is prepared by swelling a true-spherical particle by the swelling liquid containing a swelling agent and positioned on a substrate in a state of that the center portions of each of the adjacent three swollen particles are each positioned at each vertex of a regular triangle on a plane.

To provide a non-spherical resin particle having a specific shape by which sufficient strength and positional precision can be obtained, and a production method thereof.

### FIELD OF THE INVENTION

This invention relates to a non-spherical resin particle having a specific shape and a production method thereof.

### TECHNICAL BACKGROUND

Resin particles to be used as external additive of electrophotographic toners, spacer of liquid crystal displays, medical diagnosis carriers, filler of cosmetics and paints are almost ones having spherical shape which causes various problems in the practical use.

Technologies using the true-spherical resin particles as the spacer of liquid crystal display are disclosed in Patent Publications 1 and 2.

For example, both of the high cleaning suitability and high anti-filming ability of the toner cannot be satisfied when such the particle is used for the external additive of the electrophotographic toner.

Furthermore, for example, when the resin particle is sued as the spacer for the liquid crystal displays, deformation or movement of the particle is caused when relatively high stress is applied since the true-spherical particle is low in the strength. Consequently, such the particle difficultly performs sufficiently the effect of the spacer to hold a certain space at a portion where stress is often applied such as the edge portion of the liquid crystal display. In concrete, a problem that the color or brightness of the display is deformed accompanied with the bending of the film when the liquid display is pressed by a finger, and such the problem is not improved yet. A spacer having high strength and precision is desired particularly in development of flexible display.

Patent Publication 1: JP A H07-002913

Patent Publication 2: JP A K08-143313

### SUMMARY OF THE INVENTION

The invention is attained on the above background and an object of the invention is to provide a non-spherical resin particle having a specific shape, by which sufficient strength and position precision are obtained, and a production method of the particle.

The non-spherical resin particle of the invention is a non-spherical resin particle having a projection image of approximately regular hexagonal shape obtained by projecting from at least one direction, wherein each of sides of the approximately regular hexagonal shape is convex to outside, wherein the particle satisfies the formula of

(3/π)≦{a/(b×π)}≦0.995,

wherein “a” is circumference length and “b” is a major diameter of the projection image of the non-spherical particle.

It is preferable in the non-spherical resin particle of the invention that a flat portion having a circle-corresponding diameter of from 1/10 to 9/10 of the major diameter of the approximate hexagonal outline of the projection image of the non-spherical particle is formed on the face vertical to the above one direction of the non-spherical resin particle. The value is more preferably from 4/10 to 7/10.

The method for producing the above non-spherical resin particle having the specific approximate hexagonal outline in a projection image viewing at least one direction, comprises a step removing a swelling liquid from swollen particles prepared by swelling true-spherical particles by the swelling liquid containing a swelling agent and positioned on a substrate in a state of that the center portions of each of the adjacent three swollen particles are each positioned at each vertex of a regular triangle on a plane.

The method may comprise steps of; preparing true-spherical particles, arranging the true-spherical particles on a substrate in a state of that the center portions of each of the adjacent three swollen particles are each positioned at each vertex of a regular triangle on a plane wherein the true-spherical particles are swollen by the swelling liquid containing a swelling agent, and removing a swelling liquid from swollen particles.

The non-spherical resin particle of the invention is not excessively deformed or moved when the stress is applied because the projection image viewing from one direction of the particle has the specific shape of approximate regular hexagon having the specific circumference ratio; therefore, the particle has high anti-deforming ability and immobility and gives sufficient strength and positional precision so as to be suitably used for an external additive of the electrophotographic toner or the spacer of the liquid crystal display, for example.

### BRIEF DESCRIPTION OF THE DRAWINGS

FIG. 1 schematically shows the projection image of the non-spherical resin particle as one example of the invention.

FIG. 2 schematically shows the state of the non-spherical resin particle of one example of the invention viewed from one direction.

FIG. 3 schematically shows the arranged state of three resin particles of the invention in which the particles are each positioned at each of the corners of a regular triangle on a plane shown by projection image of the non-spherical particles.

### THE PREFERABLE EMBODIMENT OF THE INVENTION

The invention is described in detail below.

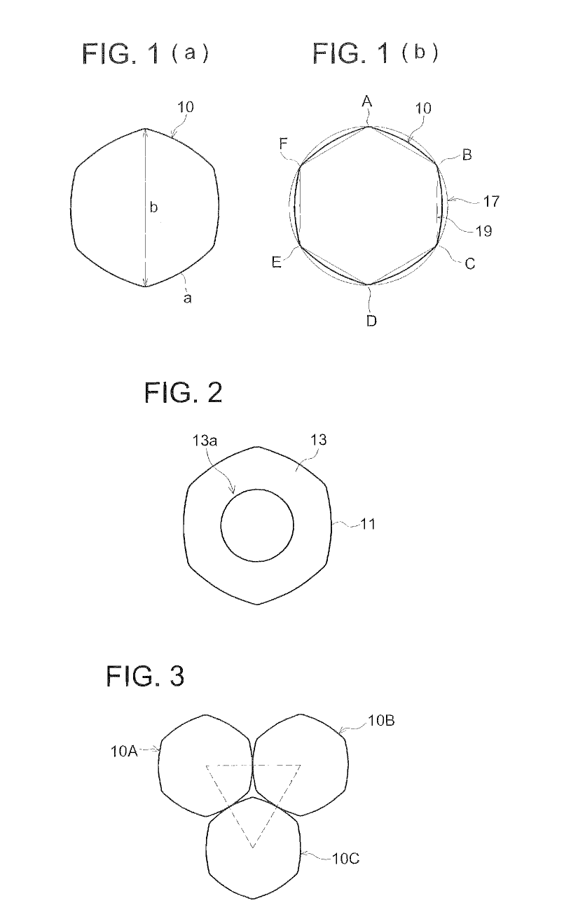

FIG. 1 displays a schematic drawing of the projection image relating to the non-spherical resin particle of the invention.

The projection image viewing from at least one direction of the non-spherical resin particle of the invention has an outline substantially approximate regular hexagonal shape as shown in FIG. 1.

The reason that the high anti-deforming ability and immobility can be obtained by the non-spherical resin particle having the specific shape is supposed that the particle has higher flatness compared with the true-spherical particle so as to make larger the total area contactable with the substrate.

The state of substantially approximate regular-hexagonal shape can be visually perceived as approximate regular hexagonal on a photograph taken by an electric field-effect scanning electron microscope (FE-SEM) in a suitable magnitude of 200,000 times when the major diameter of the resin particle is less than 0.2 μm in median diameter, 50,000 times when the major diameter is not less than 0.2 μm and less than 0.5 μm in median diameter, 20,000 times when the major diameter is not less than 0.5 μm and less than 2 μm in median diameter, 5,000 times when the major diameter is not less than 2 μm and less than 5 μm in median diameter,

2,000 times when the major diameter is not less than 5 μm and less than 20 μm in median diameter, and 500 times when the major diameter is not less than 20 μm.

In the photographs taken with such the suitable magnitude, the image of each of the non-spherical particles has a size of from about 10 to 40 mm.

The terms of “the sides are each convex to outside” means that the outline of the projection image of the sides of the non-spherical resin particle 10 are each bend to outside compared of the sides of an imaginary regular hexagon, internally touched to the projection image of the non-spherical, resin particle at each of the apexes of A to F as shown in FIG. 1(b).

In FIG. 1, 17 is an imaginary true circle circumscribing to the projection image of the particle 10.

The non-spherical resin particle of the invention satisfies the following formula when the circumference length of and the major diameter of the non-spherical resin particle are each represented by a and b, respectively.

(3/π)≦{a/(b×π)}≦0.995,

The major diameter of the non-spherical resin particle is the width of the particle corresponding to the largest distance of a pair of parallel lines each touched to different side of the image of the resin particle projected on a plane.

The formula {a/(b×π)} expresses the relative difference, hereinafter referred to as non-spherical degree, between the major diameter b of the projection image of the particle 10 and the circumference length a of a true-circle calculated from the major diameter. For example, the non-spherical degree is 1 when the projection image of the particle is true circle, and is 3/π(=0.9549296 . . . ) when the projection image of the particle is regular hexagon.

As a practical matter, the circumference length a and the major diameter b can be measured with an effective, three-digit, number for example; in such the case, 3/π in the above formula is regarded as 0.955.

The range of the above {a/(b×π)} is preferably 0.955≦{a/(b×π)}≦0.995 and more preferably 0.960≦{a/(b×π)}≦0.991.

Satisfaction of such the condition is particularly preferred for the purpose of spacer of liquid crystal from the viewpoint of inhabitation of moving on the substrate, and for the toner external additive from the viewpoint of inhibition of cleaning fault.

When the non-spherical degree {a/(b×π)} is less than 3π, the shape of the projection image of the particle is not approximate regular hexagonal, for example approximate pentagonal or approximate square. As a result of that, it is made difficult to uniformly adhere on the toner particle surface when such the particle is used as the external additive of the electrophotographic toner so that the effect of the particle cannot be sufficiently realized. On the other hand, when the non-spherical degree (a/(b×π)} is larger than 0.995, the shape of the projection image of particle nears true circle and inconveniences such as that both of the high cleaning ability and high anti-filming ability cannot be obtained at the same time are caused when the particle is added to the electrophotographic toner as the external additive.

When the non-spherical degree {a/(b×π)} of the particle is less than 3/π in the connected matter of the particles formed in the process for obtaining the non-spherical resin particles, the connected matter can be difficultly disconnected so that the independent approximate regular hexagonal non-spherical particle cannot be obtained sometimes since the particles are strongly connected with together in the connected matter.

The circumference length a of the projection image of the non-spherical resin particle 10 is measured by photographing the particles by a electric field-effect scanning electron microscope (FE-SEM) JSM-7401F, manufactured by JEOL Ltd., in a suitable magnitude of 200,000 times when the major diameter of the resin particle is less than 0.2 μm, 50,000 times when the major diameter is not less than 0.2 μm and less than 0.5 μm, 20,000 times when the major diameter is not less than 0.5 μm and less than 2 μm, 5,000 times when the major diameter is not less than 2 μm and less than 5 μm, 2,000 times when the major diameter is not less than 5 μm and less than 20 μm, and 500 times when the major diameter is not less than 20 μm in median diameter, and measuring the circumference length by an adjustable ruler or a map meter. The accelerating voltage of the FE-SEM is set 1.5 kV and the work distance is set at 1.5 mm. The maximum diameter b is the width of the particle, corresponding to the largest distance of a pair of parallel lines each touched to different side of the image of the resin particle projected on a plane.

The major diameter b of the non-spherical resin particles is preferably within the range of from 0.2 to 100 μm and more preferably from 1.0 to 30 μm though it is varied depending on the use of the non-spherical resin particle.

Such the non-spherical resin particle preferably has a specific shape such as an approximate regular hexagonal column 11 having a cross section on the horizontal direction of approximate hexagon having an approximate hemispherical head portion 13 continuously formed, with the upper side of the hexagonal columnar body 11, which has a flat portion 13a at the top of the hemispherical head, and an approximate hemispherical bottom portion continuously formed with the lower side of the hexagonal body 11, which has a flat portion, as is shown in FIG. 2.

The flat portion at the bottom of the non-spherical resin particle is formed by drying the particles in a state of touching to a base plate for arranging the swollen particles in the later-mentioned producing method of the non-spherical resin particle. The flat portion 13a at the top portion 13 can be formed by drying in a state that the particles are contacted at the upper face with pressure to a flat plate.

These flat portions preferably have a circle corresponding diameter of from 1/10 to 9/10, more preferably from 4/10 to 7/10, of the major diameter b of the projection image of the particle.

The particle is given larger flatness that that of the true-spherical particle by such the specific shape so that the total area contactable with both of the substrate and the adjacent particles can be made larger and high anti-deforming ability and immobility can be more certainly realized.

In the above, the non-spherical resin particle having the flat portion is described but it is not essential to have the flat portions at the top and the bottom portion.

The non-spherical resin particle may be one having the flat portion at one of the top and bottom portions.

The number-based median diameter of the diameter b is preferably from 0.2 to 100 μm, when the plural non-spherical resin particles are used in a gathering state.

When the number-based median diameter of b of the non-spherical particle is within the above range, the deformation of the color or brightness of the liquid crystal display caused by finger pressing can be prevented even when the non-spherical resin particle is charged at the edge portion of the liquid crystal display as the spacer.

When the plural non-spherical resin particles are used in the gathering state, the CV value of major diameter b is preferably from 1 to 15 for example.

When the CV value is within the above range, the non-spherical resin particles have high precision so that the deformation of the color or brightness of the liquid crystal display caused by finger pressing can be prevented even when the non-spherical resin particle is charged at the edge portion of the liquid crystal display as the spacer.

The CV value of the number-based major diameter b of the non-spherical resin particles is calculated by the following formula (1).

CV=(Standard deviation/Number-based medina diameter)×100 Formula (1)

As the resin for constituting the non-spherical resin particle, known various kinds of resin can be used without any limitation. In concrete, for example, styrene type resins, acryl resins such as acryl acrylate and methacryl acrylate, styrene-acryl type copolymers, polyester resins, silicone resins, olefin type resins, amide resins and epoxy resins are usable. These resins may be used singly or in combination of two or more kinds.

As the polymerizable monomer for obtaining the above resins, for example, styrene type monomers such as styrene, methylstyrene, methoxystyrene, butylstyrene, phenylstyrene and chlorostyrene; (meth)acrylate type monomers such as methyl acrylate, ethyl acrylate, butyl acrylate, ethylhexyl acrylate, methyl methacrylate, ethyl methacrylate, butyl methacrylate and ethylhexyl methacrylate; carboxylic acid type monomers such as acrylic acid and fumaric acid; divinylbenzene, ethyleneglycol dimethacrylate, tetraethyleneglycol dimethacrylate and trimethylolpropane trimethacrylate are usable. These monomers may be used singly or in combination of two or more kinds thereof.

### (Preparation of Non-Spherical Resin Particle)

As the method for producing the non-spherical resin particle of the invention, the followings can be exemplified. Swollen particles are obtained by swelling true-spherical particles prepared by an optional polymerization method such as emulsion polymerization, dispersion polymerization, seed polymerization and suspension polymerization into a swelling liquid containing a swelling agent. A single-particle layer of the swollen particles is formed by arranging the particles so that the three resin particles adjacent with together are each positioned at each of the corners of a regular triangle on a plane and the swelling agent is removed from the single particle layer. Namely the particles are dried in a state in which the non-spherical particles are restricted at the specified arranged positions by removing the swelling agent so as to obtain a connected matter in which the centers of each of three non-spherical resin particles 10A, 10B and 10C are positioned at each of the corners of a triangle on a plane and then the connected matter is disconnected. Thus the non-spherical resin particles of the invention can be obtained.

The non-spherical resin particles of the invention can be obtained, by seed polymerization using the above obtained non-spherical resin particles as the seeds. Practically, the seed particles composed of the non-spherical resin particles are dispersed in an aqueous medium and then a polymerizable monomer is added to the aqueous medium, and the monomer is polymerized as the outer layer of the seed particles. The resultant particles are separated from the aqueous medium by filtration, and washed and dried to obtain the objective non-spherical resin particles.

The true-spherical particles obtained by the polymerization method are defined as those composed of individual particles each having a shape coefficient of from 1.0 to 1.3.

The shape coefficient of the true-spherical particle is calculated by the following formula (2), which represents the sphereness of the resin particle.

Shape coefficient={(Maximum diameter/2)²×π}/Projection area Formula (2)

In the above formula (2), the maximum diameter is the width of the particle corresponding to the largest distance of a pair of parallel lines each touched to different side of the image of the resin particle projected on a plane. The projection area is the area of the projected image of the resin particle on a plane.

The shape coefficient is measured by photographing the particles by a electric field-effect scanning electron microscope (FE-SEM) JSM-7401F, manufactured by JEOL Ltd., in a suitable magnitude of 200,000 times when the diameter of the resin particle is less than 0.2 μm in median diameter, 50,000 times when the diameter is not less than 0.2 μm and less than 0.5 μm in median diameter, 20,000 times when the major diameter is not less than 0.5 μm and less than 2 μm in median diameter, 5,000 times when the major diameter is not less than 2 μm and less than 5 μm in median diameter, 2,000 times when the major diameter is not less than 5 μm and less than 20 μm in median diameter, and 500 times when the major diameter is not less than 20 μm in the median diameter, and reading out the obtained photograph by a flat head scanner GT-X700, manufactured by Seiko Epson Corp., and analyzing the photographic image by Luzex A P, manufactured by Nireco Corp. On this occasion, the shape coefficient is calculated using 100 resin particles. When 100 particles are not taken in one photograph, the shape coefficient is calculated according to 100 particles contained in plural photographs taken under the same condition.

The convex shape to outside of each side constituting the outline of the projection image of the approximate hexagonal non-spherical resin particle can be controlled by adjusting the degree of swelling by the swelling agent and the removing rate of the swelling agent. For example, fusion of the swollen particles is accelerated when the removing rate of the swelling agent is made higher so that the non-spherical degree {a/(b×π)} is lowered so that the shape of the non-spherical resin particle nears regular hexagon and the non-spherical degree {a/(b×π) is raised when the removing rate is lowered, and the shape of the non-spherical resin particle nears true-spherical though the removing rate of the swelling agent is varied depending on the kind thereof.

A concrete example of the method for producing the non-spherical resin particle when the true-spherical resin particle is prepared by the dispersion polymerization method is described below. The producing method is constituted by; (1) a process for dissolving a dispersion stabilizing agent in an alcohol type medium, (2) a monomer solution preparation process for dissolving the polymerizable monomer in the alcohol type medium, (3) a polymerization process for obtaining the true-spherical resin particles by polymerizing the polymerizable monomer, (4) a filtering-washing process for separating the true-spherical resin particles by filtration or centrifugation and washing, (5) a swelling process for obtaining the swollen particles by adding the washed time-spherical particles to a swelling liquid, (6) a swollen particle arranging process for forming a single-resin particle layer by arranging the swollen particles in the specified state on a substrate plate, (7) a drying process for obtaining a dried single resin particle layer by drying by heat the single-resin particle layer, and (8) a disconnecting the dried single resin particle layer for obtaining the non-spherical resin particles.

The filtering-washing process (4) is not essential because the true-spherical rein particles are already swollen by the alcoholic medium used as the polymerization medium and particle arranging process (6) can be carried out by using such the resin particle, although the filtering and washing process is preferably applied since the handling suitability is improved by removing unreacted polymerizable monomer remaining after polymerization and the dispersion stabilizing agent. The application of the process (5) is also not essential by the reason the same as the above that the true-spherical particles obtained by the polymerization, process (3) are already swollen, but the swelling process (5) is preferably applied since the non-spherical degree (a/(b×π)} of the non-spherical resin particles can be controlled by controlling the kind of the alcoholic medium (swelling agent) relating to the polymerization and that of the swelling agent used in the swelling process (5).

In the above, as the alcoholic medium, methanol, ethanol, isopropanol, butanol and a mixed solution thereof with water can be exemplified.

The particle obtained through the polymerization process in the above alcoholic medium is rounded as substantially true-spherical shape without any corner.

The average diameter of the true-spherical resin particle obtained by the above polymerization process is preferably within the range of from 0.2 to 10.0 μm in the volume-based median diameter.

The volume-based median diameter of the true-spherical resin particle is measured by Mastersizer-2000 manufactured by Malvern Instruments Ltd.

In concrete, 1 g of the true-spherical resin particle is put into a solution prepared by diluting 0.07 g of Charmy Quick, manufactured by Lion Corp., by 1 L of water and dispersed for 1 minute by a ultrasonic cleaner US-1, manufactured by SSD Co., Ltd., then the resultant dispersion is poured through the sample entrance into Mastersizer 2000 and begins the measurement at the time of attaining the dispersion at the measurable region.

As the swelling agent for obtaining the swollen particles in the swelling process, for example, acetone, methanol and isopropanol can be cited and a mixture of them with water can be used though the swelling agent is not specified limited as long as the agent can swell the resin particles.

The using amount of such the swelling agent is from 1 to 100,000, and more preferably 10 to 1,000, parts by weight to 100 parts by weight of the true-spherical resin particle.

As the substrate for forming the single-resin particle layer in the swollen particle arrangement process, a glass plate, PET film having no surface irregularity hindering the arrangement of the resin particles and a substrate on which dents are previously formed, hereinafter referred to as substrate having specific dents, so that the centers of adjacent three dents are each positioned at each of the corners of a regular triangle, respectively, are usable.

In the swollen particle arrangement process, the swollen particles are arranged so that the centers of each three swollen particles adjacent with together are positioned at each of the vertex of a regular triangle on a plane, namely the particles are arranged on the substrate in a state of one layer constituted by hexagonal closest, packing.

The swollen particles arranged in such the state on the substrate give projection image of the particles having regular hexagonal outline when viewing in the perpendicular direction to the substrate. Namely, line segments constituting the six sides each have straight shape.

For attaining such the arrangement, the following methods can be cited; a method can be applied in which an amount of resin, particle necessary for forming single-particle layer is put on the “substrate having the specific substrate”, in concrete on the bottom of a Petri dish shaped or a tray shaped vessel and the swelling liquid is added so as to immerse the resin particles and naturally dried and then the particles were taken out from the portion not near the verge of the vessel. Other than the above, a method in which a liquid containing the swollen resin particles obtained by immersing the true-spherical resin particles into the swelling liquid is uniformly coated on a substrate and then the swelling liquid is removed until the spaces between the swollen particles are disappeared so that the swollen resin particles are contacted with each other and the excessive swelling liquid is run short out, hereinafter such the state is referred to as a state of appropriate swelling liquid, amount, a method in which the swollen resin particles-containing liquid is sprayed on the substrate, a method in which the swollen rein particle-containing liquid is coated on the substrate and the swelling liquid was removed until the amount of the liquid is attained to the state of swelling liquid amount while applying pressure, and a method in which the swollen resin particle-containing liquid is coated on the substrate having the specified dents and the swelling liquid is removed until the amount of the liquid is attained to the state of appropriate swelling liquid amount. In the method of spraying the swollen resin particle-containing liquid onto the substrate, when excessive swelling liquid exits on the substrate on which the swollen resin particles are arranged, the excessive swelling liquid can be removed until the amount of the liquid is attained to the state of appropriate swelling liquid amount.

As the method for uniformly coating the swollen rein particle-containing liquid onto the substrate, a method using an applicator such as K Control Coater Model 101, manufactured by RK Print-Coat Instruments Ltd., is usable.

As the method for removing the swelling liquid, the method the same as the drying method in the later-mentioned drying process can be applied, and the treatment for removing the excessive swelling liquid until the amount of the liquid is attained to the state of appropriate swelling liquid amount in the swollen rein particles arranging process (6) and the drying treatment in the drying process (7) for forming the specific approximate regular hexagonal shape by drying the single-particle layer in which the state of appropriate swelling liquid amount is attained can be continuously carried out.

In the drying process, conventional known drying machines can be optionally used, and the temperature and the time for drying the single-particle layer are, for example, from room temperature to 100° C. and from 5 minutes to 10 hours, respectively though the conditions are differed according to the use of the non-spherical rein particle.

The volume of the individual non-spherical particle constituting the dried single particle layer obtained by the drying process is slightly reduced compared with that of the swollen particle and the roundness of the corners and sides thereof is formed by the suitable, elasticity of the resin constituting the swollen particle.

Thus obtained non-spherical resin particle has a special shape such as an approximate regular hexagonal column having a cross section of approximate hexagon having an approximate hemispherical head portion continuously formed with the upper side of the hexagonal column body and an approximate hemispherical bottom portion continuously formed with the lower side of the hexagonal body, which has a flat portion.

Such the non-spherical rein particle has sufficient strength and precision without deformation caused by stress because the particle has the specified shape; therefore the particle can be suitably used as the external additive for the toner and the spacer for the liquid crystal display.

The toner containing the non-spherical resin particles of the invention is described below.

The toner is composed of a toner particle containing a binder resin and a colorant, and added with an external additive composed of the non-spherical resin particles of the invention. In concrete, the toner particle is constituted by adding the non-spherical resin particles of the invention to mother particles of toner containing the binder resin and the colorant. Suitable fluidity, electrifying ability and cleaning suitability can be given to the toner by the addition of the external additive.

The adding amount of the non-spherical resin particle to the mother particle of toner is preferably within the range of from 0.05 to 5 parts by weight in total to 100 parts by weight of the mother particle of toner.

### Binder Resin

As the binder resin fox constituting the mother particle of toner, resins conventionally known as binder are usable without any limitation. In concrete, styrene type resins, acryl type resins such as an alkyl acrylate and an alkyl methacrylate, styrene-acryl type copolymers, polyester resins, silicone resins, olefin type resins, amide resins and epoxy resins can be exemplified, and the styrene type resin, acryl type resins and polyester resins each having high transparency, sharply melting ability and low viscosity in the melted state are suitable for improving the transparency and color reproducibility of piled up images. Such the resins may be used singly or in combination of two or more kinds thereof.

It is preferable that such the binder resins have a number average molecular weight (Mn) of from 3,000 to 6,000, a ratio of the weight average weight average molecular weight (Mw) to the number average molecular weight (Mn) or Mw/Mn of from 2 to 6, a glass transition point of from 50 to 70° C. and a softening point of from 90 to 110° C.

### (Colorant)

As the colorant for constituting the mother particle of toner, conventionally known dyes and pigments are usable without any limitation.

As the red colorant, C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 123, C. I. Pigment Red 139, C. I. Pigment Red 144, C. I. Pigment Red 149, C. I. Pigment Red 166, C. I. Pigment Red 177, C. I. Pigment Red 178 and C. I. Pigment. Red 122 are cited.

As the orange or yellow colorant, C. I. Pigment Orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 74, C. I. Pigment Yellow 93, C. I. Pigment Yellow 94 and C. I. Pigment Yellow 138 are cited.

As the green or cyan pigment, C. I. Pigment Blue 15, C. I. Pigment Blue 15:2, C. I. Pigment Blue 15:3, C. I. Pigment Blue 15:4, C. I. Pigment Blue 16, C. I. Pigment Blue 60, C. I. Pigment Blue 62, C. I. Pigment Blue 66 and C. I. Pigment Green 7 are cited.

As the black pigment, carbon black such as Furnace Black, Channel Black, Acetylene Black, Thermal Black and Lamp Black are cited for example.

The above colorants can be used singly or in combination of two or more kinds thereof.

The content of the colorant in the mother particle of toner is preferably from 1 to 30% by weight and more preferably from 2 to 20% by weight.

Surface-modified colorants are also usable. Conventionally know surface modifying agents such as silane coupling agents, titanium coupling agents, and aluminum coupling agents are preferably usable.

### (Parting Agent)

A parting agent contributing to inhibit offset phenomenon may be contained in the mother particle of toner. The parting agents such as polyethylene wax, oxide-type polyethylene wax, polypropylene wax, oxide-type polypropylene wax, carnauba wax, Sasol wax, rice wax, jojoba wax and honey wax are usable.

The content of the parting agent in the mother particle of toner is usually from 0.5 to 5 parts by weight and preferably from 1 to 3 parts by weight to 100 parts by weight of the binder resin constituting the mother particle of toner.

### (Diameter of Mother Particle of Toner)

The average diameter of such the mother particles of toner is preferably from 4 to 10 μm, and more preferably from 6 to 9 μm, in volume-based median diameter. The average diameter can be controlled according to the concentration of a coagulation agent (salting out agent) or the adding amount of an organic solvent in the emulsion polymerization coagulation method, the fusion time and the composition of the polymer. The transferring efficiency is raised so as to improve the image quality of halftone, and the image quality of fine line and dot is also improved when the volume-based median diameter of the mother particles is within the above range.

The volume-based median diameter of the mother particles of toner is measured and calculated by using Coulter Multisizer 3, manufactured by Beckman Coulter Inc., connected with a data processing computer system, manufactured by Beckman Coulter Inc.

In concrete, 0.2 g of the mother particle powder of toner is wetted by 20 ml of a surfactant, for dispersing the toner, for example, a neutral detergent containing a surfactant diluted by purified water by 10 times, and dispersed for 1 minute by ultra sonic waves to prepare a toner dispersion. The toner dispersion is injected by a pipette to a beaker containing an electrolyte Isoton II, manufactured by Beckman Coulter Inc., placed on the sample stand until the concentration indicated by the measuring apparatus becomes 8%. Measured values with reproducibility can be obtained by making the concentration to that within the above range. In the measuring apparatus, count number of the particle and the aperture diameter are set at 25,000 and 50 μm, respectively, and the measuring rang of from 1 to 30 μm is divided into 256 parts and the frequency of the particle diameter is calculated. Then the particle diameter at 50% from the larger side of integrating volume ratio {volume D50% diameter) is defined as the volume-based median diameter.

### (Developer)

The above toner may be used as a magnetic or non-magnetic single component developer or a two-component developer prepared, by mixing with a carrier. When the toner is used as the two-component developer, magnetic particles composed of a known material, for example, a metal such as iron, ferrite and magnetite, and alloys of such the metals and aluminum or lead can be used as the carrier and ferrite particle is particularly preferred. A coated carrier composed of magnetic particles coated with resin and a binder type carrier composed of the magnetic fine particles dispersed in a binder resin are also usable.

As the coating resin constituting the coated carrier, olefin type resins, styrene type resins, silicone type resins, ester resins and fluororesins are usable. As the resin constituting the dispersion type carrier, known resins such as styrene-acryl resins, polyester resins, fluororesins and phenol resins are usable.

The volume-based median diameter of the carrier is preferably from 20 to 100 μm and more preferably from 20 to 60 μm. The volume-based median diameter is measured by typically a laser refractive particle size distribution measuring apparatus HEROS, manufactured by Sympatec GmbH, having a wet dispersion apparatus.

As the preferable carrier, a carrier using a silicone type resin, a copolymer (graft resin) resin of organopolysiloxane and vinyl type monomer or a polyester rein can be cited from the viewpoint of anti-spending ability, and the carrier coated by a resin obtained by reaction of the copolymer of organopolysiloxane and vinyl type monomer (graft resin) with isocyanate is preferably from the viewpoint of durability, environment resistive stability and anti-spending ability.

When the toner containing such the non-spherical resin particles as the external additive is used, a certain amount of the non-spherical particles are accumulated in the space between the cleaning blade and the photoreceptor so that slipping of the toner through the cleaning blade is inhibited and high, cleaning ability can be obtained. Moreover, the material causing filming on the photoreceptor is polished out by the accumulated non-spherical resin particles so that high anti-filming ability can be obtained.

The invention is described above but the invention is not limited to the above-mentioned and various variations can be applied.

For example, it is allowed as long as that the projection image of the particle viewing from one face of the non-spherical resin particle has a specified approximate regular hexagonal shape.

### EXAMPLES

Concrete examples of the invention are described below but the invention is not limited to the examples.

### Example 1

### Preparation of Non-Spherical Resin Particle by Dispersion Polymerization Method

To a vessel having a stirrer, a heat-cooling device, a nitrogen introducing device and a raw material-assisting agent charging device, a solution prepared by dissolving 6.3 g of poly(vinyl pyrrolidone) in 242 g of methanol was charged and the internal temperature was raised by 60° C. while stirring at a rate of 100 rpm under a nitrogen gas current. To the resultant liquid, 66.6 g of styrene and 0.8 g of azobisisobutyronitrile were added and polymerized for 24 hours. Thus dispersion (a) of true-spherical fine particles composed of polystyrene was obtained. The resin particles were separated from the true-spherical fine particle dispersion (a) by a centrifuge and washed twice by methanol replacing to obtain true-spherical fine particles (a). The true-spherical fine particles (a) had a volume-based median diameter of 2.0 μm and a CV value of 7.5. The average diameter and the CV value were the values measured by Mastersizer 2000, manufactured by Malvern Instruments Ltd. A swollen particle dispersion (a) prepared by immersing 56 g of the true-spherical fine particles (a) into 124 g of a swelling liquid prepared by mixing ethanol and water in a ratio of 8/1 was coated, on a glass plate and uniformly spread by K Control Coater Model 101, manufactured by PK Print-Coat Instruments Ltd., and dried by heating at 50° C., and peeled and treated by a homogenizer CM-100, manufactured by As One Corp., to obtain non-spherical resin particles (A), the projection image of which had the approximate regular hexagonal shape. The circumference length a of the projection image of the non-spherical resin particles (A) was 6.02 μm and the major diameter b of projection image of the particle was 1.98 μm, CV value of b was 7.62 and the non-spherical degree {a/(b×π)} was 0.968.

The circumference length a of the non-spherical resin particle was measured by photographing by the field effect scanning electron microscope (FE-SEM) JSM-7401F, manufactured by JEOL Ltd., in a suitable magnitude of 200,000 times when the major diameter of the resin particle is less than 0.2 μm in median diameter, 50,000 times when the major diameter is not less than 0.2 μm and less than 0.5 μm in median diameter, 20,000 times when the major diameter is not less than 0.5 μm and less than 2 μm in median diameter, 5,000 times when the major diameter is not less than 2 μm and less than 5 μm in median diameter, 2,000 times when the major diameter is not less than 5 μm and less than 20 μm in median diameter, and 500 times when the major diameter is not less than 20 μm in median diameter, and measuring the circumference length by an adjustable ruler on the obtained microscopic photograph, and major diameter b of the projection image was the width of the particle corresponding to the largest distance of a pair of parallel lines each touched to different side of the image of the resin particle projected on a plane. The projection area is the area of the projected image of the resin particle on a plane.

### Example 2

### Preparation of Non-Spherical Resin Particles by Seed Polymerization Method

Seed polymerization was carried out using the above non-spherical resin particles (A) as the deeds. Fifty grams of dispersion liquid containing the non-spherical resin particles (A) composed of polystyrene having a solid content of 4%) was prepared. Besides, a micro-emulsion was prepared, by dispersing 1.95 g of 1-chlrodecane and 0.067 g of sodium dodecylsulfate in 51.9 g of purified water, and the above non-spherical resin particle dispersion were mixed with the resultant micro-emulsion and stirred for 18 hours at room temperature. Thus obtained mixture was charged into a vessel having a stirrer, neat-cooling device, nitrogen introducing device and raw material and assistant charging device, and 1.9 g of styrene, 1.9 g of methyl methacrylate and 0.034 g of azobisisobutyronitrile were added and stirred for 2 hours. And then, 60 g of a 10%-aqueous solution of poly(vinyl alcohol) was added and further stirred for 1 hour. Moreover, the internal temperature was raised by 70° C. and the liquid was stirred for 8 hours to obtain a resin particle dispersion (b) having high monodisperse degree. Resin, particles were separated from the resin particle dispersion (b) by a centrifuge and washed twice by replacing methanol and twice by replacing water and dried to obtain non-spherical resin particles (B) giving a projection image of the particle of approximate hexagonal shape. The non-spherical resin particles (B) had a median diameter of 2.5 μm, a CV value of 6.3. The non-spherical degree {a/(b>π)} was 0.980.

The circumference length a and major diameter b of the non-spherical resin particles (B) were, measured in the same manner as in Example 1.

### Example 3

### Preparation of Non-Spherical Resin Particle by Dispersion Polymerization

Into a vessel having a stirrer, neat-cooling device, nitrogen introducing device and raw material and assistant charging device, a solution prepared by dissolving 6.3 g of poly(vinyl pyrrolidone) in 200 g of methanol and 40 g of water was charged and internal temperature was raised by 60° C. while stirring at a stirring rate of 100 rpm under a nitrogen current. To the solution, 66.6 g of methyl methacrylate and 0.8 g of azobisisobutyronitrile were added and polymerized for 24 hours to obtain a true-spherical fine particle dispersion (c) composed of poly(methyl methacrylate) having high monodisperse degree. The resin particles were separated from the true-spherical fine particle dispersion (c) by a centrifuge and washed twice by replacing methanol to obtain true-spherical fine resin particles (c). The true-spherical fine resin particles (c) had a volume-based median diameter of 2.6 μm and a CV value of 12.3. Swollen particle dispersion (c) prepared by immersing 56 g of the true-spherical fine resin particles (c) in 124 g of a swelling liquid composed of methanol and water in a ratio of 9/1 was sprayed onto bi-axially stretched. PET film and uniformly spread by K Control Coated Model 101, manufactured by RK Print-Coat Instruments Ltd., to form a single-particle layer of the resin particle on the bi-axially stretched PET film and dried at 60° C. Then the layer was peeled and treated by a homogenizer CM-100, manufactured by As One Corp., to obtain non-spherical resin particles (C), the projection image of which had the approximate regular hexagonal shape. The non-spherical degree {a/b×π} of the non-spherical resin particles (C) was 0.993.

The circumference length a and the major diameter of the projection image of the non-spherical resin particles (C) were measured in the same manner as in Example 1.

### Example 4

True spherical fine particles (a) were obtained in the same manner as in Example 1, and 72 g of which were immersed in 168 g of a swelling liquid composed of a mixture of ethanol and water in a ratio of 8/2 to prepare a swollen particle dispersion (a3). The swollen particle dispersion (a3) was coated on a glass plate and uniformly spread by K Control Coater Model 101, manufactured by RK Print-Coat Instruments Ltd. And then the coated layer was contacted by pressing onto polyetherimide substrate on which many dents having an average diameter of 0.5 μm were provided to form a single resin particle layer on the substrate and dried by heating at 50° C. The dried layer was peeled and treated by the homogenizer CM-100, manufactured by As One Corp., to obtained non-spherical resin particles (D), the projection image of which had an approximate regular hexagonal shape. The non-spherical degree {a/b×π} of the non-spherical resin particles (D) was 0.959,

The circumference length a and the major diameter b of the projection image of the non-spherical resin particles (D) were measured in the same manner as in Example 1.

### Comparative Example 1

### Preparation of Resin Particle by Dispersion Polymerization Method

Into a vessel having a stirrer, a heat-cooling device, a nitrogen introducing device and a raw material-assisting agent charging device, a solution prepared by dissolving 6.3 g of poly(vinyl pyrrolidone) in 242 g of methanol was charged and the internal temperature was raised by 60° C. while stirring at a rate of 100 rpm under a nitrogen gas current. To the liquid, 66.6 g of styrene and 0.8 g of azobisisobutyronitrile were added and polymerized for 24 hours. Thus true-spherical fine particle dispersion (x) composed of polystyrene was obtained, which had high monodispersed degree. Resin particles were separated form the true-spherical fine particle dispersion (x) by a centrifuge and washed twice by water replacing instead of washing twice by ethanol replacing to obtain true-spherical fine particles (x). The true-spherical fine particles (x) have a volume-based median diameter of 1.7 μm and a CV value of 7.3. The true-spherical fine particles were filtered and dried to obtain resin particles (X). The shape of the resin particle (X) was true-spherical.

### Comparative Example 2

### Preparation of Resin Particle by Dispersion Polymerization Method

True-fine particles (X) were obtained in the same manner as Comparative Example 1. A single-particle layer was formed on a glass plate using a swollen particle dispersion (y) prepared by immersing 56 g of the true-spherical fine particles (x) in 124 g of a swelling solution composed of a mixture of methanol and water in a ratio of 1/9 and dried at 50° C. by heating. The dried layer was peeled and treated by the homogenizer CM-100, manufactured by As One Corp., to obtain resin particles (Y). The projection image of the resin particles (Y) was approximate regular hexagonal shape and the non-spherical degree of which was 0.998.

The circumference length a and the major diameter b of the projection image of the non-spherical resin particles (Y) were measured in the same manner as in Example 1.

### Comparative Example 3

### Preparation of Resin Particle by Suspension Polymerization Method

In a mixture composed of 17.5 g of poly(vinyl alcohol) of polymerization degree of 500, 0.35 g of Pelex SSH, manufactured by Kao Corp., and 300 g of purified water, 35 g of styrene and 0.42 g of azobisisobutyronitrile was added and subjected to emulsifying treatment by TK Homomixer for 20 minutes at 7,000 rpm to obtain a emulsion. The emulsion was charged into a vessel having a stirrer, a heat-cooling device, a nitrogen introducing device and a raw material-assisting agent charging device, and stirred at a stirring rate of 100 rpm and 70° C. for 8 hours to obtain a true-spherical fine particles (z) composed of polystyrene. The resin particles were separated from the true-spherical fine resin particles (z) by a centrifuge and washed twice by methanol replacing to obtain true-spherical fine particles (z). The true-spherical fine particles (z) had a volume-based median diameter of 2.8 μm and a CV value of 32.5. A true-spherical fine particle dispersion (z) prepared by dispersing 30 g of the true-spherical fine particle in 100 g of a swelling liquid, composed of a mixture of methanol and water in a ratio of 1/9 was coated on a glass plate and uniformly spread by K Control Coater Model 101, manufactured by RK Print-Coat Instruments Ltd., to form a single-particle layer on the glass plate, but the particles in the layer were not arranged in complete hexagonal closest packing state. The layer was dried by heating at 50° C., peeled and treated by the homogenizer CM-100, manufactured by As One Corp., to obtain resin particles (Z). The resin particle in the resin particles (Z) is not uniform in the shape thereof and the projection image thereof is true-spherical or polygonal.

### Example of Preparation of Toner

### Preparation Example 1 of Resin Particle Dispersion

To a vessel having a stirrer, a heat-cooling device, a nitrogen introducing device and a raw material-assisting agent charging device, a surfactant solution prepared by dissolving 4 parts by weight of sodium dodecylsulfonate in 2,800 parts by weight of deionized water was charged and the internal temperature was raised by 80° C. while stirring at a stirring rate of 200 rpm under a nitrogen current. To the solution, a solution prepared by dissolving 10 parts by weight of potassium persulfate in 400 parts by weight of deionized water added and, then a monomer mixture composed of 530 parts by weight of styrene, 200 parts by weight of n-butyl acrylate, 70 parts by weight of acrylic acid and 16 parts by weight of n-octylmercaptan was dropped spending 90 minutes and polymerized by keeping the temperature for 120 minutes to prepare a latex (A1).

To a monomer liquid composed of 116 parts by weight of styrene, 47 parts by weight of n-butyl acrylate and 2 parts by weigh of n-octylmercaptan, 70 parts by weight of polyethylene wax was added and dissolved at 80° C. to prepare a monomer solution. On the other hand, a surfactant solution prepared by dissolving 3 parts by weight of sodium dodecylsulfonate in 700 parts by weight of deionized water was heated by 80° C. and mixed with the above monomer solution. And then the mixture was treated for 30 minutes by a mechanical dispersing machine CLEARMIX, manufactured by M TECH Co., Ltd., to prepare an emulsified dispersion.

To a vessel having a stirrer, a heat-cooling device, a nitrogen introducing device and a raw material-assisting agent charging device, 1,700 parts by weight of deionized water and 160 parts by weight of the foregoing latex (A1) were charged and the internal temperature was raised, by 80° C. while stirring at a stirring rate of 200 rpm. To the resultant liquid, the foregoing emulsified dispersion and a solution prepared by dissolving 6 parts by weight of potassium persulfate in 240 parts by weight of deionized water were added and polymerized for 2 hours to obtain a latex (B1).

To the latex (B), a solution prepared by dissolving 5 parts by weight of potassium persulfate in 220 parts by weight deionized water was added, and a monomer mixture liquid composed of 338 parts by weight of styrene, 110 parts by weight of n-butyl acrylate and 7 parts by weight of n-octylmercaptan was dropped spending 90 minutes and polymerized by holding the temperature for 120 minutes to obtain a latex (C1) having a volume-based median diameter of 156 nm.

### Producing Example of Colorant Dispersion

In 300 parts by weight of deionized water, 12 parts by weight of sodium n-dodecylsulfate was dissolved by stirring, and 84 parts by weight of carbon black Regal 330, manufactured by Cabot Corp., was gradually added and dispersed by the mechanical dispersing machine CLEARMIX, manufactured by MTECH Co., Ltd., to obtain a colorant dispersion (1) having a volume-based median diameter of 170 nm.

### Production Example of Toner

To a vessel having a stirrer, a heat-cooling device, a nitrogen introducing device and a raw material-assisting agent charging device, 1,300 parts by weight of deionized water, 790 parts by weight of the foregoing latex (C1) and 163 parts by weight of the above Colorant Dispersion (1) were charged, and the pH of the resultant mixture was adjusted to 10 bay adding a 5 mole/L-solution of sodium hydroxide while continuing the stirring. Then a solution prepared by dissolving 27 parts by weight of magnesium chloride hexahydrate in 27 parts by weight of deionized water was added spending 10 minutes while stirring. After that, the temperature was raised by 86° C. and the diameter of associated particle was measured in such the state by Coulter Counter TA-III, manufacture by Beckman Coulter Inc., and a solution prepared by dissolving 67 parts by weight of sodium chloride in 270 parts by weight of deionized water was added to stop growing of the particles at the time when the volume-based median diameter became 6.6 μm. And then the particles were subjected to a treatment for making sphere shape having a sphere degree of 0.94 by continuing heating and, after cooling, repeatedly subjected to filtration and washing and dried to obtain toner mother particles (1) having a volume-based median diameter of 6.4 μm. The circular degree and the volume based median diameter were each measured by a flow type particle image analyzing apparatus FPIA-2000, manufactured by Toa Iyo Denshi Co., Ltd., and Coulter Multisizer TA-III, manufactured by Beckman Coulter Inc., respectively.

### <Evaluation by Practical Machine>

To 100 parts by weight of the toner mother particle (1), 0.5% by weight of silica fine particle H-2000, manufactured by Hoechst Japan Ltd., 0.5% by weight of titanium dioxide fine particle T-805, Ninon Aerosil Co., Ltd., and 0.5% by weight of each of the foregoing non-spherical resin particles (A) to (D) and resin particles (X) to (Z) were added and treated, by Henschel mixer to prepare Toners (A) to (D) and Comparative Toners (X) to (Z). Each of Toners (A) to (D) and Comparative Toners (X) to (Z) was mixed with silicone-acryl-coated carrier in a ratio of 6:94 to prepare Developers (A) to (D) and Comparative Developer (X) to (Z), respectively. Evaluation by practical machine, on the image forming properties of Developers (A) to (D) and Comparative Developer (X) to (Z) using BIZHUB C520, manufactured by Konica Minolta Business Technologies Inc. Results are listed in Table 1.

### (Image Property)

Contamination on the image caused by fault of cleaning of the photoreceptor was observed as to initial image and that after 1,000 sheets of image formation. The evaluation results were ranked as follows:

A: No contamination was observed on the image.

B: No problem was caused even though contamination on the image was observed.

C: Contamination causing problems in the practical use was observed.

TABLE 1

| | | | | | | | Evaluation | |
|---|---|---|---|---|---|---|---|---|
| | | | | | | Non- | result | |
| | | Shape of | | | | spherical | | After |
| | Resin | resin | Median | | | degree | | 1000 |
| | particle | particle | diameter | a | b | (a/b × π) | Initial | sheets |
| Example 1 | A | Approximate | 2.0 | 6.02 | 1.98 | 0.968 | A | A |
| | | regular | | | | | | |
| | | hexagonal | | | | | | |
| Example 2 | B | Approximate | 2.5 | 7.48 | 2.43 | 0.980 | A | A |
| | | regular | | | | | | |
| | | hexagonal | | | | | | |
| Example 3 | C | Approximate | 2.6 | 7.86 | 2.52 | 0.993 | A | A |
| | | regular | | | | | | |
| | | hexagonal | | | | | | |
| Example 4 | D | Approximate | 2.0 | 5.81 | 1.93 | 0.959 | A | A |
| | | regular | | | | | | |
| | | hexagonal | | | | | | |
| Comparative | X | True- | 1.7 | 5.09 | 1.62 | — | C | C |
| example 1 | | spherical | | | | | | |
| Comparative | Y | Approximate | 1.7 | 5.08 | 1.62 | 0.998 | B | C |
| example 2 | | regular | | | | | | |
| | | hexagonal | | | | | | |
| Comparative | Z | Mixture of | 2.9 | 6.92 | 2.31 | — | C | C |
| example 3 | | true- | | | | | | |
| | | spherical and | | | | | | |
| | | polygonal | | | | | | |

As above-mentioned, it is confirmed that image contamination caused by the fault of cleaning is not formed after printing of 1,000 sheets of images and superior cleaning ability can be obtained for long duration by the use of Developers (A) to (D) each containing the non-spherical resin particles of the invention.

The non-spherical resin particle of the invention has the three dimensional shape having higher flatness compared with the true-spherical resin particle, and the total area of the particle contactable with the substrate is increased by such the shape so that the particle is made difficultly to be moved on the substrate and to have higher covering ratio to the substrate. The particle can be suitably applied as, for example, an external additive of electrophotographic toner, spacer of liquid crystal display, carrier for medical diagnosis, standard particle for particle diameter measurement, filling agent for chromatography, filler for cosmetics and paint, by applying the properties of such the characteristic three-dimensional shape.

What is claimed is:

1. A non-spherical resin particle having a projection image of approximately regular hexagonal shape obtained by projecting the non-spherical resin particle from at least one direction, in which each of sides of the approximately regular hexagonal shape is convex to outside, wherein the particle satisfies the formula of
(3/π)≦{a/(b×π)}≦0.995,
wherein “a” is a circumference length and “b” is a major diameter of the projection image of the non-spherical particle.

2. The non-spherical resin particle of claim 1, wherein the particle satisfies the formula of
0.955<{a/(b×π)}0.990.

3. The non-spherical resin particle of claim 1, wherein the particle satisfies the formula of
0.960≦{a/(b×π)}≦0.985.

4. The non-spherical resin particle of claim 1, which has a flat portion having a circle-corresponding diameter of from 1/10 to 9/10 of the major diameter of the projection image of approximately regular hexagonal shape on a face which is vertical to the one direction of the non-spherical resin particle.

5. The non-spherical resin particle of claim 4, which has a flat portion having a circle-corresponding diameter of from 4/10 to 7/10 of the projection image of approximately regular hexagonal shape on a face which is vertical to the above one direction of the non-spherical resin particle.

6. The non-spherical resin particle of claim 1, wherein a major diameter b of the non-spherical resin particle is from 0.2 to 100 μm.

7. The non-spherical resin particle of claim 6, wherein the major diameter b of the non-spherical resin particle is from 1.0 to 30 μm.

8. A set of non-spherical resin particles composed of a plurality of the non-spherical resin particle of claim 1, wherein CV value of b of the non-spherical resin particles is from 1 to 15.

9. A set of non-spherical resin particles of claim 8, wherein a number-based, median diameter of the diameter b is from 0.2 to 100 μm.

10. A toner comprising colored particles and the non-spherical resin particles of claim 1.

11. A method for producing the non-spherical resin particle of claim 1, which comprises a step removing a swelling liquid from swollen particles positioned on a substrate in a state of that center portions of each of adjacent three swollen particles are each positioned at each vertex of a regular triangle on a plane wherein the swollen particles are prepared by swelling true-spherical particles by the swelling liquid containing a swelling agent.

12. A method for producing the non-spherical resin particle of claim 1, which comprises steps of;
preparing true-spherical particles,
arranging the true-spherical particles on a substrate in a state of that the center portions of each of adjacent three swollen particles are each positioned at each vertex of a regular triangle on a plane, wherein the true-spherical particles are swollen by the swelling liquid containing a swelling agent, and
removing a swelling liquid from swollen particles.
